(19) United States
(12) Patent Application Publication
(10) Pub. No.: US 2007/0160969 A1
(43) Pub. Date: Jul. 12, 2007

(54) Method and Apparatus for Associating User Evaluations with Independent Content Sources

(76) Inventors: Benny M. Barton, Dallas, TX (US); Seetharaman Satishram, Coppell, TX (US); Ravi Seshadri, Plano, TX (US); David M. Harrel, Dallas, TX (US)

Correspondence Address: BAKER BOTTS L.L.P., 2001 ROSS AVENUE, SUITE 600, DALLAS, TX, 75201-2980, US

(21) Appl. No.: 11/306,781

(22) Filed: Jan. 11, 2006

(51) Int. Cl. G09B 7/00

(52) U.S. Cl. 434/323

(57) ABSTRACT

A method, computer program product, and data processing system for delivering educational material and performing an evaluation of the progress of a recipient of that material are disclosed. According to a preferred embodiment, a community of instructor-users assembles a database of evaluation material corresponding to existing media content available via the Internet or through other electronic means (video, CD-ROM, etc.). Students utilize special client software (and/or hardware) to access the media content, where the client retrieves not only the media content itself, but also any evaluation material that is associated with that media content. As a student views the content, he/she is presented with questions from the evaluation material, which he/she must answer. The student's responses to the evaluation material are recorded and may be used to adjust the difficulty level and topics covered, as appropriate.

### TECHNICAL FIELD

The present invention relates generally to computer-aided instruction (CAI), and specifically, to a method and apparatus for supplementing primary sources of informational content with a means for evaluating the educational progress of a user of that content.

### DESCRIPTION OF THE RELATED ART

Since the introduction of the World Wide Web and the subsequent commercialization of the Internet, the world has become a considerably more connected place. No longer bound to the primitive communications interfaces of the past, the Internet is now host to a variety of powerful communications media, including interactive hypertext browsing (the World Wide Web), instant messaging, streaming video and audio, and multimedia electronic mail.

There has been much interest in recent years in using Internet-based media for the delivery of educational materials. U.S. Pat. No. 6,898,411 (ZIV-EL et al.) 2005 May 24, for example, describes a system in which an instructor can assemble a multimedia lesson from existing Web content by augmenting that content with evaluation material. The specific actions taken by the student in reviewing the lesson content and in responding to the evaluation material are recorded in a database to allow the instructor to gauge the progress of each student. A similar system is described in U.S. Patent Application Publication 20050158698 (BOYS) 2005 Jul. 21.

Other work in this general area has focused not only on the computer as a delivery medium for educational content but as a tool for providing detailed analysis of student progress. Such analysis can be utilized to automatically customize the delivery of educational content to meet a particular student's needs. For example, U.S. Pat. No. 6,146,148 (STUPPY) 2000 Nov. 11, describes a system for automated delivery of instructional material, which evaluates a student's performance, assembles a student profile based on that performance, and makes adjustments to the content delivered to the student based on that profile.

The majority of these existing systems are tailored to classroom use, generally with a single instructor. In many situations, however, it is desirable to make educational materials available outside of a conventional classroom environment, for educational enrichment or for adult professional education, for example. Further, it is desirable to provide an ability to adapt existing non-pedagogical, but nonetheless educational, content to be used in a structured educational setting by a wide audience of users.

What is needed, therefore, is a system for automated delivery of educational content and evaluation materials that is adaptable to environments outside of the traditional classroom model. The present invention provides a solution to this and other problems, and offers other advantages over previous solutions.

### SUMMARY OF THE INVENTION

The present invention provides a method, computer program product, and data processing system for delivering educational material and performing an evaluation of the progress of a recipient of that material. According to a preferred embodiment, a community of instructor-users assembles a database of evaluation material corresponding to existing media content available via the Internet or through other electronic means (video, CD-ROM, etc.). Students utilize special client software (and/or hardware) to access the media content, where the client retrieves not only the media content itself, but also any evaluation material that is associated with that media content. As a student views the content, he/she is presented with questions from the evaluation material, which he/she must answer. The questions presented to the student are selected according to a profile of the student's current skill level in the particular subject being presented, which is also maintained in a database. The student's responses to the evaluation material are recorded and may be used to adjust the student's profile accordingly.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a diagram illustrating the overall architecture of a distributed computing system implementing a preferred embodiment of the present invention;

FIG. 2 is a diagram illustrating the semantics of the entity-relationship diagrams provided in FIGS. 3-4;

FIG. 3 is an entity-relationship (E-R) diagram illustrating the structure of an example content repository in accordance with a preferred embodiment of the present invention;

FIG. 4 is an entity-relationship (E-R) diagram illustrating the structure of an example used database in accordance with a preferred embodiment of the present invention;

FIGS. 5-9 are a series of diagrams illustrating the operation of a preferred embodiment of the present invention in the context of video media;

FIG. 10 is a diagram illustrating the use of tutorial mode in accordance with a preferred embodiment of the present invention;

FIG. 11 is a flowchart representation of a process of presenting educational/evaluation material to a user in accordance with a preferred embodiment of the present invention;

FIG. 12 is a block diagram of a set-top box in which a preferred embodiment of the present invention may be implemented; and

FIG. 13 is a block diagram of a data processing system in which a preferred embodiment of the present invention may be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

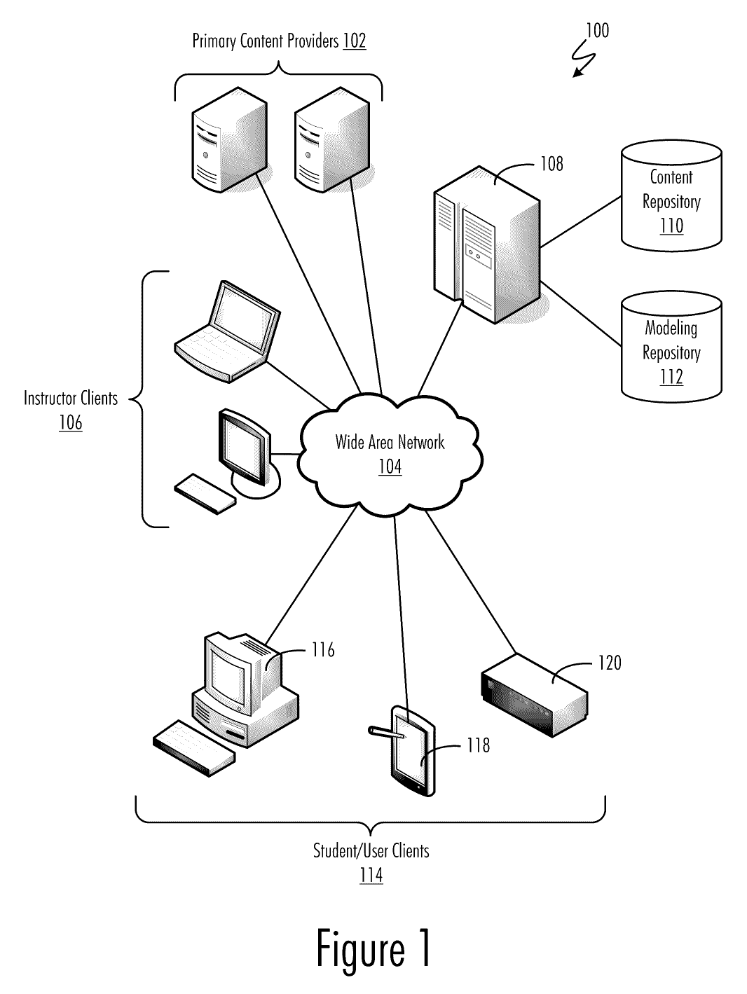

FIG. 1 is a diagram illustrating the overall architecture of a distributed computing system 100 implementing a preferred embodiment of the present invention. A basic principle of operation of a preferred embodiment of the present invention is to associate user evaluation material—that is, questions and other content intended to evaluate the user's knowledge or skills—with third-party media content, referred to herein as “primary media content” or “primary content.” Primary media content includes a large variety of types of electronic media, including Web pages and other Web-based content, digital streaming video, digital streaming audio, analog audio/video signals, recordings, and broadcasts. Since most of these types of media can be provided through Web servers and other digital network-connected servers, these third-party primary content sources are represented in FIG. 1 in the form of servers 102 connected to a wide area network 104, typically the Internet. Primary content providers 102 may include a number of websites, for example. Alternatively, however, primary media content can come from local sources (such as video players, portable media players, etc.) associated with student client devices 114 or through other telecommunications means (such as via satellite link or terrestrial radio transmission).

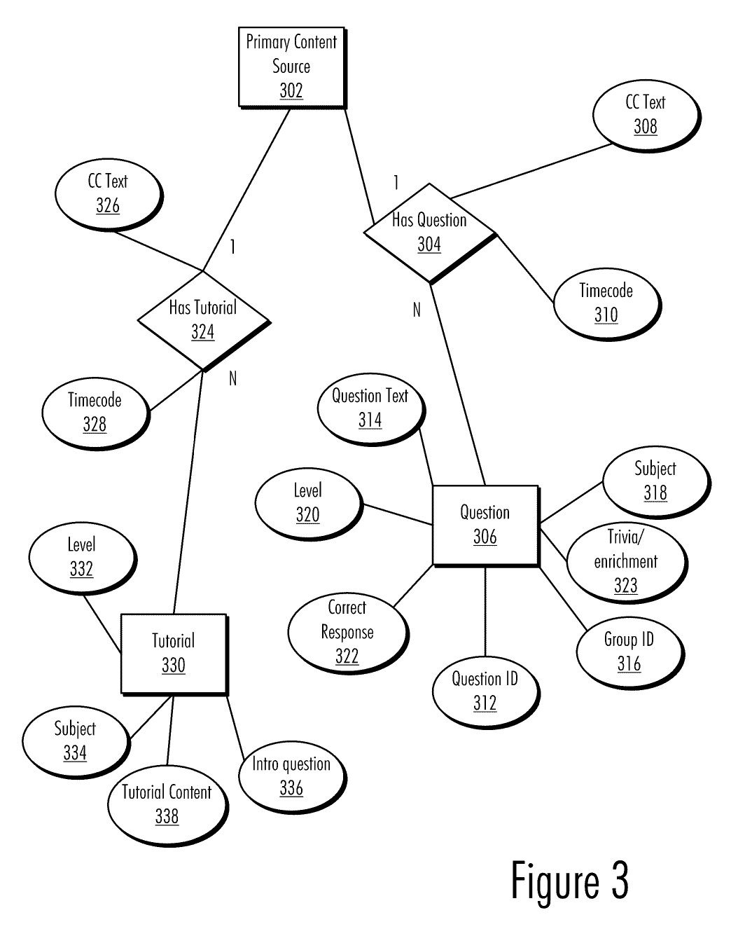

Evaluation material is created at instructor clients 106, which are computer systems connected to wide area network 104. Instructor clients 106 include client software used by human “instructors” to connect to central server 108. We use the term “instructors” to refer to the human creators of the evaluation material to be associated with primary media content. In a preferred embodiment, instructor clients 106 utilize conventional web browsers to access a web-based interface to central server 108. The instructors use this web-based interface to author evaluation material and associate that evaluation material with items of primary media content from primary content providers 102. Central server 108 stores this authored information in content repository 110, an example schema for which is described in detail in FIG. 3.

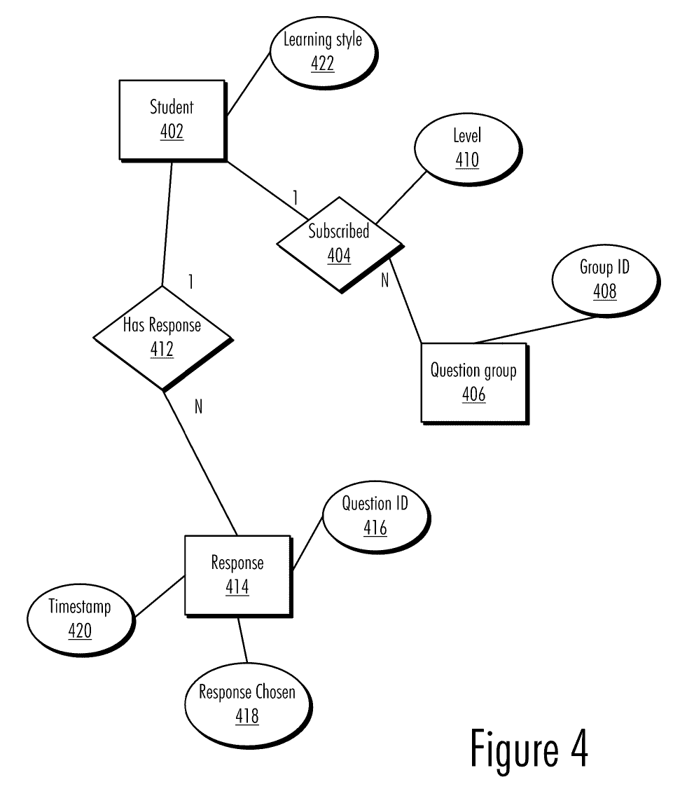

Central server 108 also maintains a database of information about “users” (also referred to herein as “students”), who represent the ultimate end-users of the system—that is, the persons receiving the educational/evaluation content. Modeling repository 112 includes user profile information that tracks the progress of each student. An example schema for modeling repository 112 is described in detail in FIG. 4.

At this point it should be noted that although the term “student” is used throughout this document to denote the end-user to which the evaluation and/or tutorial content is presented, the term is not intended to limit the use of the invention to the traditional paradigm of traditional, formal classroom instruction. The term is used here in the broadest sense, to encompass any and all users who are being instructed and/or evaluated using an embodiment of the present invention. For example, a “student,” in the context of the present invention, may be a professional person who is being evaluated for his or her knowledge of a particular field for purposes of certification. Another example of a “student,” in the context of the present invention, might be someone who wishes to learn a skill (such as a foreign language) individually, without formalized classroom instruction. Yet another example of a “student” might be a person who uses an embodiment of the present invention to answer trivia questions solely for entertainment purposes.

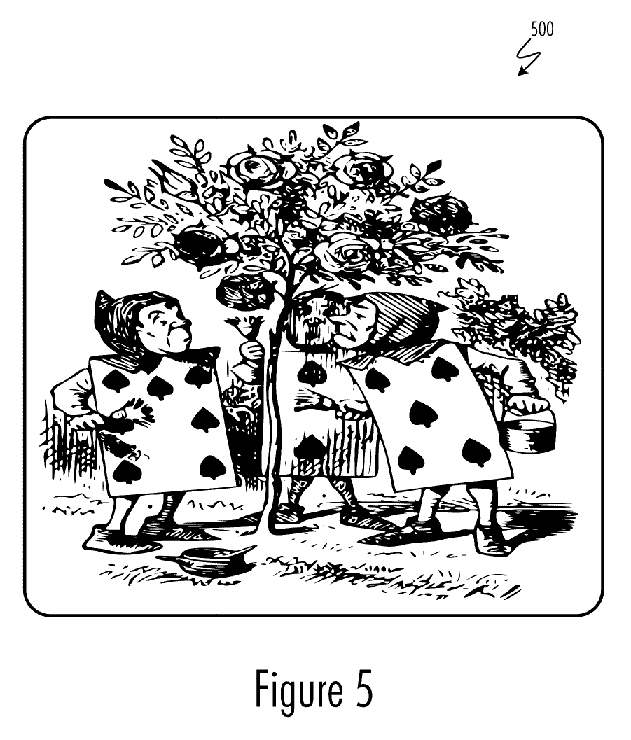

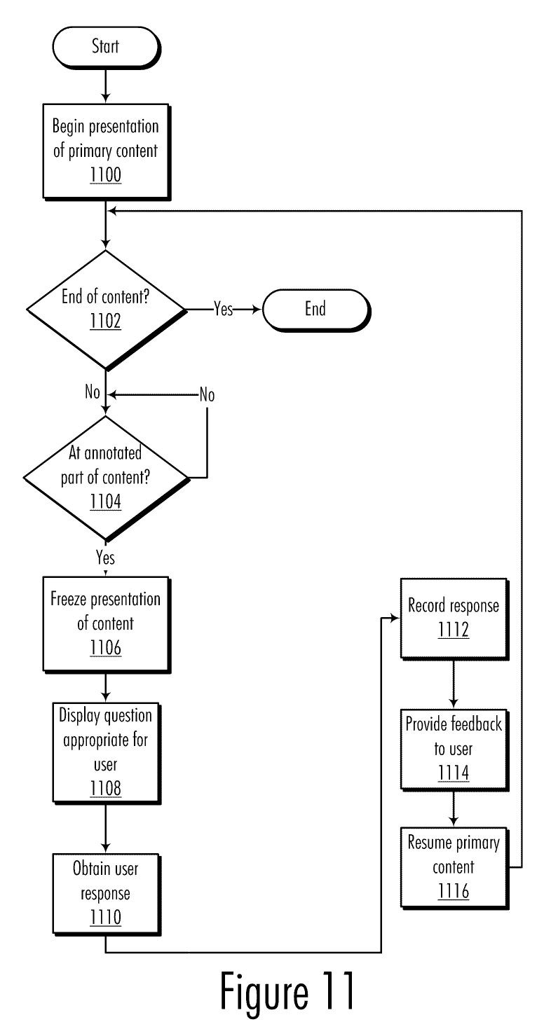

Student clients 114, also connected to wide area network 104, represent the client computing/communication platforms through the primary media content and associated evaluation material are presented to the students. Student clients 114 obtain the primary media content (either from primary content providers 102, through network 104, or through local or other means, such as from a video cassette recorder or video disc player, for example) and also access central server 108 to obtain evaluation material (from content repository 110) associated with that primary content and suitable for a student's current level of skill, as reflected by the student's profile in user data base 112. Student clients 114 control the presentation of the primary content and evaluation material to the student-user, collect user responses to the evaluation material, and record those responses in modeling repository 112 for further evaluation and analysis by an instructor, by the student himself/herself, or by an otherwise-authorized party. The general operation of student clients 114 is described by example in FIGS. 5-10 and in flowchart form in FIG. 11.

In addition to evaluating students' performance, a preferred embodiment of the present invention may also be used in a “tutorial mode” to provide additional information to supplement primary content material without necessarily evaluating the student. In “tutorial mode,” when a student needs a more formalized review in a particular area or topic, the student may indicate his/her need for review and be presented with additional review material that supplements the primary content and prepares the student for later instruction or evaluation.

A strength of the present invention is that student clients 114 may take a variety of different forms. A personal computer 116 equipped with specialized client software (such as specialized Web browser or video player software) that can request evaluation material from central server 108 in conjunction with requesting primary content from primary content providers 102 (such as described in flowchart form in FIG. 11) is one possible student client. Similarly a portable device such as a tablet computer or portable digital assistant (PDA) 118 may also be similarly equipped to request primary content as well as associated evaluation material. A mobile telephone or other form of portable telecommunications/computing device may also be used as a student client device.

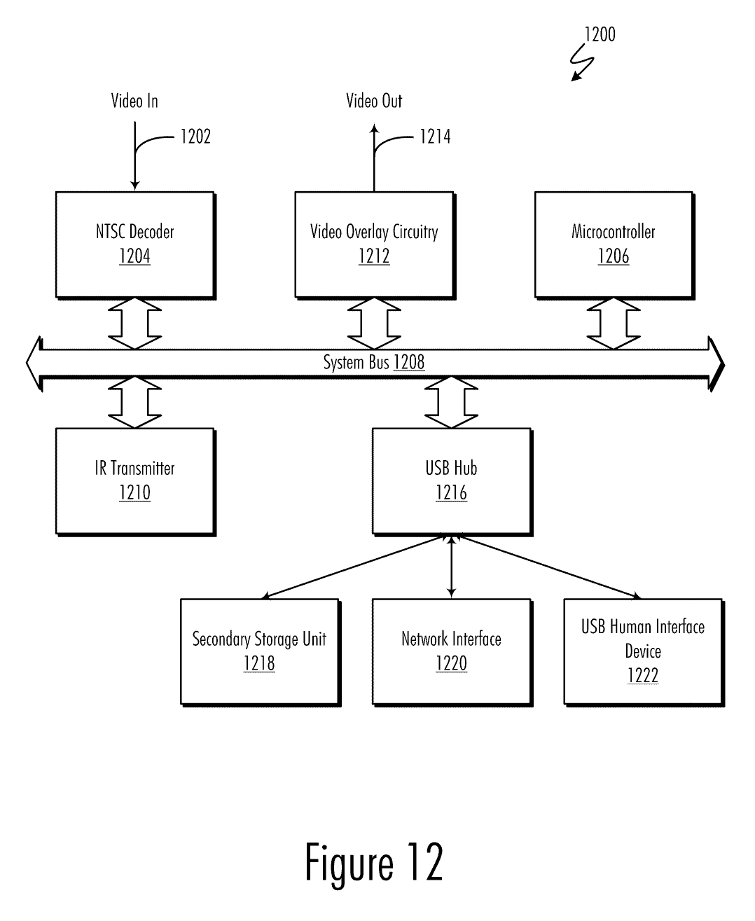

Another example of a possible student client is in the form of a television set-top box 120. Set-top box 120 is designed to take in a video feed (e.g., from a video cassette recorder or DVD player), track the current position within the video, and determine (through consultation with central server 108) if there are any appropriate questions to be displayed in conjunction with one or more scenes in the video. In the event that such a question exists, set-top box 120 pauses the video playback, superimposes the question over the paused video frame, and obtains a user response. A block diagram of set-top box 120 is provided in FIG. 12.

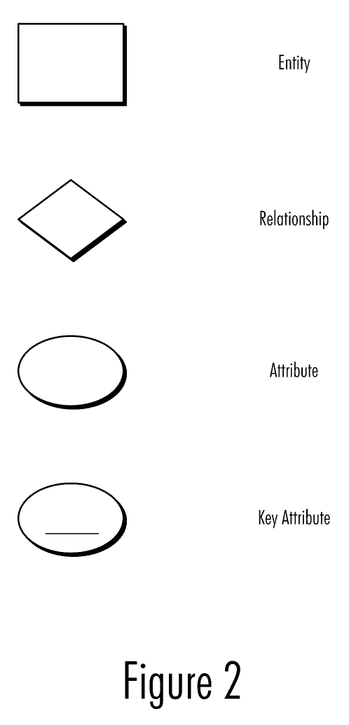

FIGS. 3 and 4 are E-R diagrams providing example schemas illustrating the basic structure of content repository 110 and modeling repository 112. The E-R (entity-relationship) approach to database modeling provides a semantics for the conceptual design of databases. With the E-R approach, database information is represented in terms of entities, attributes of entities, and relationships between entities, where the following definitions apply. The modeling semantics corresponding to each definition is illustrated in FIG. 2. FIG. 2 is adapted from Elmasri and Navathe, Fundamentals of Database Systems, 3rd Ed., Addison Wesley (2000), pp. 41-66, which contains additional material regarding E-R diagrams and is hereby incorporated by reference. Database schemas modeled using the E-R approach may be systematically and algorithmically converted directly from their E-R representations into relational databases (in Structured Query Language, or SQL, for example).

Entity: An entity is a principal object about which information is collected. For example, in a database containing information about personnel of a company, an entity might be “Employee.” In E-R modeling, an entity is represented with a box.

Attribute: An attribute is a label that gives a descriptive property to an entity (e.g., name, color, etc.). Two types of attributes exist. Key attributes distinguish among occurrences of an entity. For example, in the United States, a Social Security number is a key attribute that distinguishes between individuals. Descriptor attributes merely describe an entity occurrence (e.g., gender, weight). As shown in FIG. 2, in E-R modeling, an attribute is represented with an oval tied to the entity (box) to which it pertains.

Relationships: A relationship is a connectivity exhibited between entity occurrences. Relationships may be one to one, one to many, and many to many, and participation in a relationship by an entity may be optional or mandatory. For example, in the database containing information about personnel of a company, a relation “married to” among employee entity occurrences is one to one (if it is stated that an employee has at most one spouse). Further, participation in the relation is optional as there may exist unmarried employees. As a second example, if company policy dictates that every employee have exactly one manager, then the relationship “managed by” among employee entity occurrences is many to one (many employees may have the same manager), and mandatory (every employee must have a manager).

As shown in FIG. 2, in E-R modeling a relationship is represented with a diamond if it relates one or two entities, and is represented with an n-sided polygon if it relates more than two entities. The cardinality ratio (one-to-one, one-to-many, etc.) in a relationship is denoted by the use of the characters “1” and “N” to show 1:1 or 1:N cardinality ratios, or through the use of explicit structural constraints, as shown in FIG. 2.

Turning now to FIG. 3, an E-R diagram of content repository 110 is shown. As shown in the diagram, a primary content source (entity 302), which may represent a Web site, audio/visual content, or the like, may be associated (relationship 304) with one or more questions (entity 306). In the case of an audio/visual primary content source, that question may be associated with closed captioning text (attribute 308) or timecode information (attribute 310) corresponding to the particular location in the primary content source at which the question should be presented to a user.

Each question (entity 306) in the content repository has a unique question ID (attribute 312) and a number of other attributes that define the question, including the text of the question itself (attribute 314), the subject area of the question (attribute 318), a difficulty level for the questions (attribute 320), and a correct response to the questions (attribute 322). An additional “group ID” (attribute 316) allows certain questions to be associated with particular groups of users, instructors, or particular courses of instruction. For example, a class of students led by an instructor might have certain questions associated with that class. By specifying a group ID (attribute 316) for those questions, the questions can be more easily associated with that particular class, as will become apparent upon inspection of FIG. 4. It should also be apparent from FIG. 3 that a particular primary media source (or even a particular position within the source) may be associated with multiple questions of varying levels of difficulty. Which question(s) are presented to a user depends on the user's level of skill, as represented in modeling repository 112.

In order that a preferred embodiment of the present invention be useful to the highly motivated student or to be useful for entertainment purposes, an additional “trivia/enrichment” attribute 323 is provided. “Trivia/enrichment” attribute 323 is intended to allow certain questions to be labeled as optional enrichment exercises or, alternatively, for amusement or curiosity interest only (i.e., trivia questions). This allows a user the ability to opt into viewing additional optional questions, if desired.

In order to support the aforementioned “tutorial mode,” a primary content source (entity 302) may also be associated (relationship 324) with one or more tutorials (entity 330). In the case of an audio/visual primary content source, a tutorial may be associated with closed captioning text (attribute 326) or timecode information (attribute 328) corresponding to the particular location in the primary content source at which the option to enter a tutorial should be presented to a user.

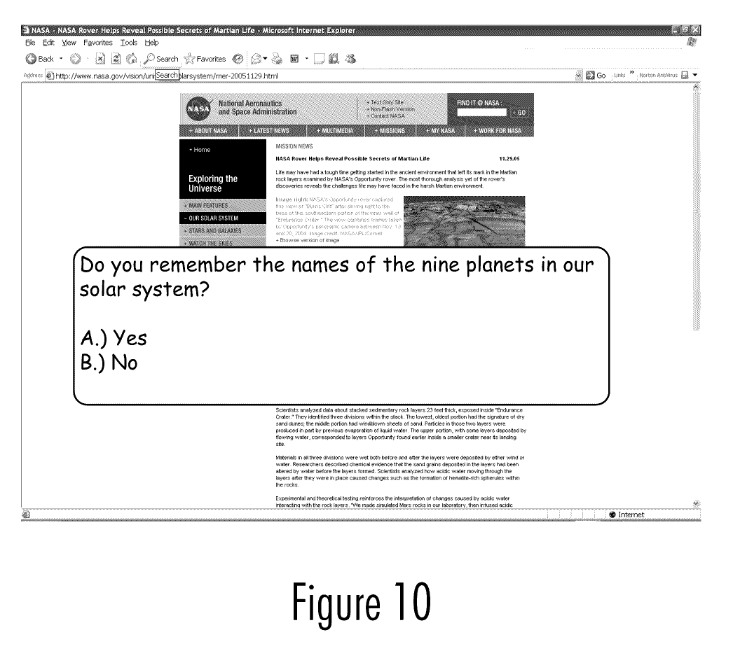

Each tutorial (entity 330) has an associated level (attribute 332) and subject area (attribute 334), which correspond to the level and subject level attributes (attributes 320 and 318, respectively) associated with questions (entity 306) and which may be used to determine the suitability of a particular tutorial to a particular user. A tutorial also has an introductory question (attribute 336), which is presented to the user in order to allow the user the option of entering the tutorial or not. For example, in FIG. 10, where a user is viewing a NASA (National Aeronautics and Space Administration) website regarding the planet Mars, the user is asked if he/she remembers the names of the nine planets. If the user answers “No,” then appropriate tutorial content (attribute 338) is displayed to the user to review the topic. This feature is particularly useful for ensuring a user's level of prerequisite knowledge before introducing a new topic.

FIG. 4 is an E-R diagram representing an example implementation of modeling repository 112. A student (user) (entity 402) is subscribed (relationship 404) to one or more question groups (entity 406). Each question group has a particular group ID (attribute 408), corresponding to the group ID attribute (316) in the content repository of FIG. 3. The student (entity 402) is subscribed (relationship 404) to the particular question group (entity 406) at a particular “level” (attribute 410) which corresponds to the current progress or skill level of that student with respect to a particular group of questions (as identified by group ID).

A student (entity 402) may make multiple question responses (relationship 412), which are recorded in the database (entity 414). A student's actual response (attribute 418) to a particular question (identified by question ID attribute 416) is recorded (entity 414) along with a timestamp of when the response took place (attribute 420). This information may be used for analysis of the student's progress, as well as for determining when to advance the student's level (attribute 410) with respect to a given question group (entity 406).

A preferred embodiment of the present invention may also be utilized to determine a particular learning style (attribute 422) of a student. By applying data mining techniques to a student's results over time, a particular learning style or styles (e.g., auditory, visual, tactile, global, procedural, etc.) can be identified for a student. A student's learning style, once determined, may be used to select those questions, tutorials, and other learning aids and materials that are most appropriate to that student, thus individualizing the learning experience.

FIGS. 5-9 are a series of diagrams illustrating the operation of a preferred embodiment of the present invention in the context of video media (e.g., streaming video displayed on a computer system, such as client computer 116 in FIG. 1, or a video signal feed such as might be processed by set-top box 120 in FIG. 1). FIG. 5 shows a screenshot of a children's video 500. In this example, video 500 is a presentation intended for entertainment purposes, specifically a video rendition of the classic children's story “Alice in Wonderland” by Lewis Carroll.

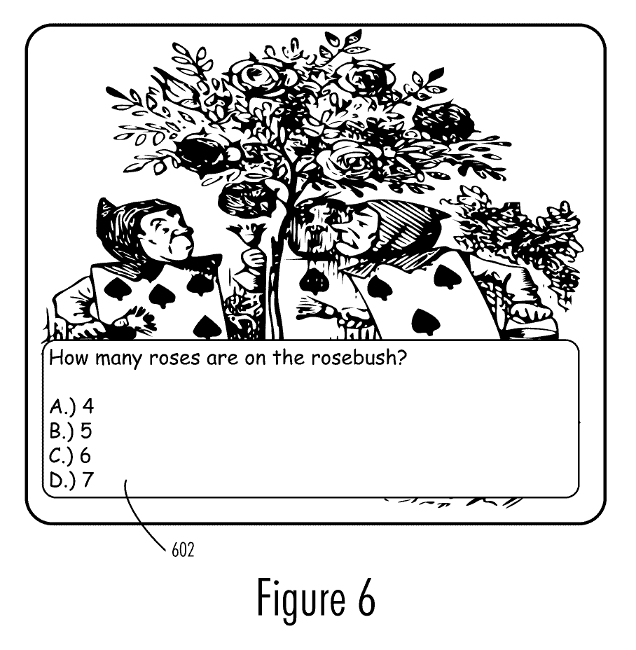

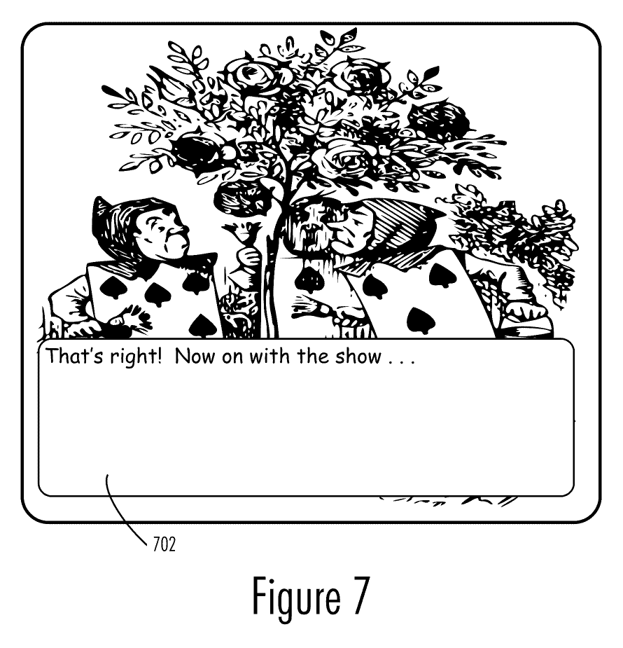

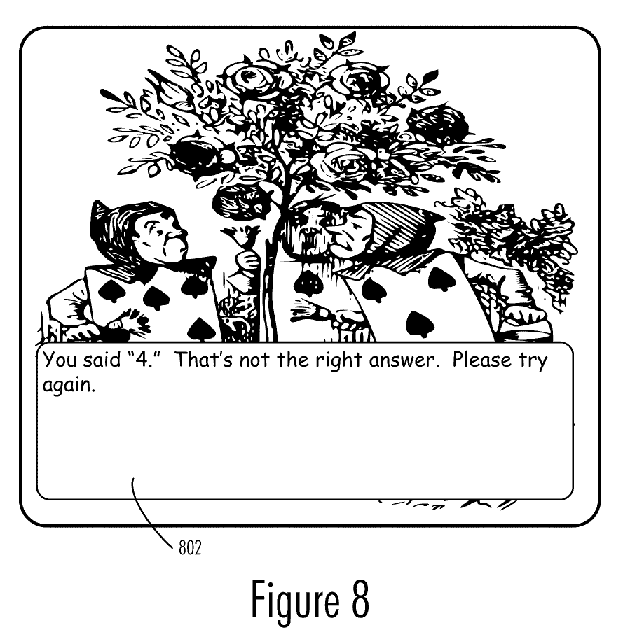

At this point in the video, there is a question that can be asked about the contents of the screen. In FIG. 6, the video is paused, the appropriate question 602 superimposed on the video display, and the client machine (computer, set-top box, etc.) awaits a response from the user (student). If the response is correct, as in FIG. 7, the student is rewarded (display 702) and normal playback of the video resumes. If the response is incorrect, as in FIG. 8, the user is so informed (display 802) and the user must try again (as in FIG. 6).

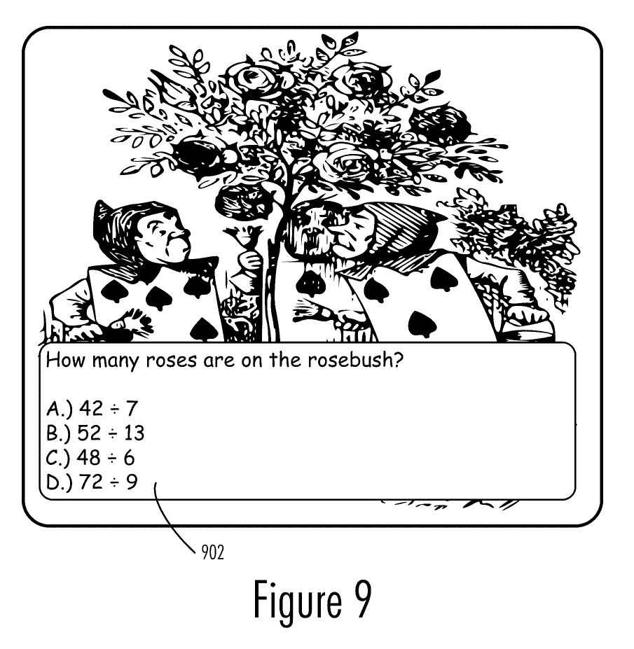

The questions that are chosen for a particular user are based on that user's profile and are appropriate for that user's level of skill and/or need for remediation. Thus, while the example provided in FIG. 6 is a simple question asking the user only to count the number of roses on the rosebush (such as might be asked of a small child, for example). A more advanced student, who is learning arithmetic, for example, might instead be presented with a question that requires recall of an arithmetic fact, as in FIG. 9.

FIG. 11 is a flowchart representation of a process of presenting educational/evaluation material to a user in accordance with a preferred embodiment of the present invention. The client system (computer system, set-top box, PDA, mobile telephone, etc.) first begins presentation of an item of primary media content (a website, video, audio clip, etc.) (block 1100). While the content is being presented (block 1102:No), a determination is made as to whether the presentation of the primary content has reached an “annotated part” of the content (block 1104)—that is, a location at which an appropriate question or other evaluation means can be presented to the user.

Once such a location has been reached, normal presentation of the primary comment is halted (frozen) (block 1106). A question that is appropriate to the particular user (with respect to his/her profile) is selected a presented to the user (block 1108), and the user's response thereto is obtained (block 1110). The response is recorded in the student's profile/database (e.g., FIG. 4) for subsequent analysis (block 1112). At this point, the student's profile may be further updated to reflect “graduation” or “promotion” to a higher level, if so merited by the user's performance. Likewise, if the user is having trouble in a particular area, the user's level may be lowered. Feedback (positive or negative) is then provided to the user so that the user knows whether the question was answered correctly or not (block 1114). Then, presentation of the primary content is resumed (block 1116). Alternatively, presentation of the primary content could be deferred until the user reattempts the question and answers correctly, as in FIG. 7.

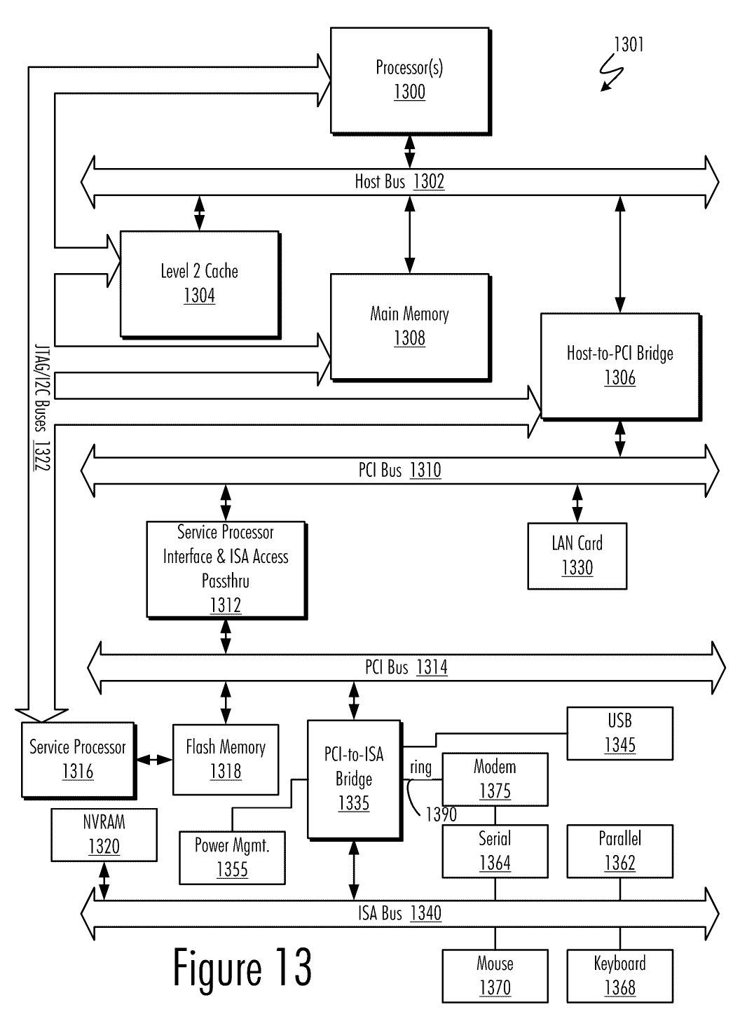

One skilled in the art will recognize that any of a wide number of different kinds of client devices (including, but not limited to the types of client devices 114 shown in FIG. 1) may be used in the context of present invention, without limitation and without departing from the scope and spirit thereof. Most of the types of primary media content available for use with a preferred embodiment of the present invention will be displayable by a computer system, such as that illustrated in FIG. 13, which is representative of most personal computers, workstations, and the like, although there are many other kinds of hardware platforms, such as portable digital assistants (PDAs), mobile telephones, portable media players, and the like, which are equally applicable.

One such client device, which may be utilized in the context of a video presentation (as in FIGS. 5-9), is a television set-top box (e.g., set-top box 120 in FIG. 1). FIG. 12 is a block diagram of an exemplary set-top box 1200 of this kind. Set-top box 1200 takes a video signal feed 1202 (such as from a Digital Versatile Disc (DVD) player, video cassette recorder, etc.) as input and returns a video signal 1214 as output. For the majority of the time (while the primary video content is being played), set-top box 1200 returns as output the same signal video signal received as input.

In the United States, conventional analog television is encoded in NTSC (National Television System Committee) format, so an NTSC decoder 1204 is used to obtain information from raw video feed 1202. An example of a monolithic integrated circuit video decoder that might be used for this purpose is the SAA7114 video decoder circuit produced by Philips Semiconductors, which can also decode the other primary analog video formats, PAL and SECAM, which are widely used in Europe and elsewhere. Video decoder 1204, in addition to recovering image intelligence from raw video feed 1202, also reads timecodes (which reveal the current position within the video recording) and closed captioning/teletext information. Microcontroller 1206 monitors the output of video decoder 1204 via system bus 1208 to determine the currently-displayed position in the video (either directly, through timecodes, or indirectly, by monitoring closed captioning information for recognized portions of dialog or other caption information). One skilled in the art will recognize that although set-top box 1200 is configured to receive a standard analog video feed, other forms of video data transmission, including digital formats (such as HDTV-High Definition Television) may be used and suitable decoder circuitry utilized in lieu of the analog NTSC Decoder 1204.

As an alternative to external video feed 1202 as a source of the primary video content, the video to be displayed may be obtained directly from secondary storage 1218, which is connected to system bus 1208 through USB hub 1216. Secondary storage unit 1218 may take the form of any of a wide variety of storage media, including optical disc drives (e.g., compact disc, DVD), hard disk drives, non-volatile memory (e.g., flash memory), and the like.

Universal Serial Bus (USB) hub 1216 interfaces system bus 1208 with a number of peripherals, including network interface 1220, which permits communication with the Internet or other wide-area network for the purpose of determining what questions, if any, are associated with the currently-displayed video.

In typical operation, microcontroller 1206 timecode and/or closed captioning information from NTSC decoder 1204 to look up, via a network connection at network interface 1220, questions associated with the currently-displayed video. In the event microcontroller 1206 determines that an appropriate question is associated with the currently-playing video sequence, microcontroller 1206 activates infrared transmitter 1210, which transmits an infrared remote-control signal to the source of the video feed (typically a DVD player or VCR) to pause the source video. Video overlay circuitry 1212 is then used to superimpose the retrieved question over the paused video.

USB human interface device (HID) 1222 is used to obtain the user's response to the displayed question. Examples of suitable human interface devices include, but are not limited to, keyboards, mice, game controllers, joysticks, and the like. The user's result is then uploaded to a central server (e.g., server 108 in FIG. 1) to update the user's profile.

Once the question has been correctly answered, video overlay circuitry 1212 discontinues superimposing image information on outgoing video feed 1214 and infrared transmitter 1210 transmits a remote control signal to the source of the video to resume normal video playback.

FIG. 13 illustrates information handling system 1301, which is a simplified example of a computer system capable of performing the computing operations described herein with respect to a preferred embodiment of the present invention. Computer system 1301 includes processor 1300 which is coupled to host bus 1302. A level two (L2) cache memory 1304 is also coupled to host bus 1302. Host-to-PCI bridge 1306 is coupled to main memory 1308, includes cache memory and main memory control functions, and provides bus control to handle transfers among PCI bus 1310, processor 1300, L2 cache 1304, main memory 1308, and host bus 1302. Main memory 1308 is coupled to Host-to-PCI bridge 1306 as well as host bus 1302. Devices used solely by host processor(s) 1300, such as LAN card 1330, are coupled to PCI bus 1310. Service Processor Interface and ISA Access Pass-through 1312 provides an interface between PCI bus 1310 and PCI bus 1314. In this manner, PCI bus 1314 is insulated from PCI bus 1310. Devices, such as flash memory 1318, are coupled to PCI bus 1314. In one implementation, flash memory 1318 includes BIOS code that incorporates the necessary processor executable code for a variety of low-level system functions and system boot functions.

PCI bus 1314 provides an interface for a variety of devices that are shared by host processor(s) 1300 and Service Processor 1316 including, for example, flash memory 1318. PCI-to-ISA bridge 1335 provides bus control to handle transfers between PCI bus 1314 and ISA bus 1340, universal serial bus (USB) functionality 1345, power management functionality 1355, and can include other functional elements not shown, such as a real-time clock (RTC), DMA control, interrupt support, and system management bus support. Nonvolatile RAM 1320 is attached to ISA Bus 1340. Service Processor 1316 includes JTAG and I2C buses 1322 for communication with processor(s) 1300 during initialization steps. JTAG/I2C buses 1322 are also coupled to L2 cache 1304, Host-to-PCI bridge 1306, and main memory 1308 providing a communications path between the processor, the Service Processor, the L2 cache, the Host-to-PCI bridge, and the main memory. Service Processor 1316 also has access to system power resources for powering down information handling device 1301.

Peripheral devices and input/output (I/O) devices can be attached to various interfaces (e.g., parallel interface 1362, serial interface 1364, keyboard interface 1368, and mouse interface 1370 coupled to ISA bus 1340. Alternatively, many I/O devices can be accommodated by a super I/O controller (not shown) attached to ISA bus 1340.

In order to attach computer system 1301 to another computer system to copy files over a network, LAN card 1330 is coupled to PCI bus 1310. Similarly, to connect computer system 1301 to an ISP to connect to the Internet using a telephone line connection, modem 1375 is connected to serial port 1364 and PCI-to-ISA Bridge 1335.

While the computer system described in FIG. 13 is capable of supporting the methods described herein, this computer system is simply one example of a computer system. Those skilled in the art will appreciate that many other computer system designs are capable of performing the processes described herein.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an;” the same holds true for the use in the claims of definite articles.

What is claimed is:

1. A method comprising:
accessing media content;
determining if an item of evaluation material is associated with the media content;
presenting the evaluation material to a user in conjunction with the media content;
obtaining a response to the evaluation material from the user; and
recording the response.

2. The method of claim 1, wherein the media content is accessed via a Web browser and wherein the Web browser, in response to accessing the media content, obtains the evaluation material in addition to the media content.

3. The method of claim 1, wherein the media content is streaming media and wherein the item of evaluation material is associated with a particular point in the streaming media.

4. The method of claim 3, wherein the streaming media is streaming video.

5. The method of claim 1, wherein the media content is a video signal and wherein presenting the evaluation material includes superimposing the evaluation material on the video signal.

6. The method of claim 1, further comprising:
pausing presentation of the media content in conjunction with presenting the evaluation material.

7. The method of claim 1, further comprising:
selecting the evaluation material based on a user profile associated with the user.

8. The method of claim 7, further comprising:
updating the user profile in accordance with the recorded response.

9. A computer program product in a computer-readable medium, comprising functional descriptive material that, when executed by a computer, causes the computer to perform actions that include:
accessing media content;
determining if an item of evaluation material is associated with the media content;
presenting the evaluation material to a user in conjunction with the media content;
obtaining a response to the evaluation material from the user; and
recording the response.

10. The computer program product of claim 9, wherein the media content is accessed via a Web browser and wherein the Web browser, in response to accessing the media content, obtains the evaluation material in addition to the media content.

11. The computer program product of claim 9, wherein the media content is streaming media and wherein the item of evaluation material is associated with a particular point in the streaming media.

12. The computer program product of claim 11, wherein the streaming media is streaming video.

13. The computer program product of claim 9, wherein the media content is a video signal and wherein presenting the evaluation material includes superimposing the evaluation material on the video signal.

14. The computer program product of claim 9, comprising additional functional descriptive material that directs the computer to perform additional actions of:
pausing presentation of the media content in conjunction with presenting the evaluation material.

15. The computer program product of claim 9, comprising additional functional descriptive material that directs the computer to perform additional actions of:
selecting the evaluation material based on a user profile associated with the user.

16. The computer program product of claim 15, comprising additional functional descriptive material that directs the computer to perform additional actions of:
updating the user profile in accordance with the recorded response.

17. A data processing system comprising:
at least one processor;
storage associated with the at least one processor; and
a set of instructions in the storage, wherein the at least one processor executes the instructions to perform actions of:
accessing media content;
determining if an item of evaluation material is associated with the media content;
presenting the evaluation material to a user in conjunction with the media content;
obtaining a response to the evaluation material from the user; and
recording the response.

18. The data processing system of claim 17, wherein the media content is accessed via a Web browser and wherein the Web browser, in response to accessing the media content, obtains the evaluation material in addition to the media content.

19. The data processing system of claim 17, wherein the media content is streaming media and wherein the item of evaluation material is associated with a particular point in the streaming media.

20. The data processing system of claim 19, wherein the streaming media is streaming video.

21. The data processing system of claim 17, wherein the media content is a video signal and wherein presenting the evaluation material includes superimposing the evaluation material on the video signal.

22. The data processing system of claim 19, wherein the at least one processor executes the set of instructions to perform actions of:
pausing presentation of the media content in conjunction with presenting the evaluation material.

23. The data processing system of claim 19, wherein the at least one processor executes the set of instructions to perform actions of:
selecting the evaluation material based on a user profile associated with the user.

24. The data processing system of claim 23, wherein the at least one processor executes the set of instructions to perform actions of:
updating the user profile in accordance with the recorded response.
